(19) United States
(12) Patent Application Publication
(10) Pub. No.: US 2011/0250488 A1
(43) Pub. Date: Oct. 13, 2011

(54) SECONDARY BATTERY

(76) Inventor: Sin-Young Park, Yongin-si (KR)

(21) Appl. No.: 12/916,339

(22) Filed: Oct. 29, 2010

Related U.S. Application Data
(60) Provisional application No. 61/323,274, filed on Apr. 12, 2010.

(51) Int. Cl. H01M 2/04; H01M 2/02

(52) U.S. Cl. 429/163

(57) ABSTRACT

Battery modules have a plurality of electrode assemblies in which the electrode tabs of electrode assemblies are easily attached to the battery cases by a common insulator including receptacles for receiving the electrode assemblies. These configurations enable easy manufacture of medium- and large-sized battery modules with a plurality of electrode assemblies. In some embodiments, a battery module includes an insulator capable of mounting a plurality of electrode assemblies and receptacles in the insulator for receiving a portion of each electrode assembly.

### CROSS-REFERENCE TO RELATED APPLICATION

This application claims priority to and the benefit of U.S. Provisional Application No. 61/323,274, filed on Apr. 12, 2010, in the United States Patent and Trademark Office, the entire content of which is incorporated herein by reference.

### BACKGROUND OF THE INVENTION

1. Technical Field

The invention relates to secondary batteries, and more specifically, to secondary batteries including a plurality of electrode assemblies in which the electrode tabs of the electrode assemblies can be easily attached to the battery cases to manufacture medium- and large-sized battery modules.

2. Background

Secondary batteries can be repeatedly charged and discharged, unlike primary batteries which cannot be repeatedly charged. Low-capacity secondary batteries having one cell are used for small, portable electronic devices, such as mobile phones, notebook computers, and camcoders. High-capacity secondary batteries including a plurality of battery cells connected in a pack have gained interest for use as power supplies for driving motors, such as those of hybrid electric cars, etc.

The high-capacity secondary batteries, which are connected with each other in series to drive a motor (e.g., of an electric vehicle, etc.), require high power and may be used as a battery module. Therefore, high-capacity batteries have been actively researched.

However, when a module including a plurality of small batteries is used as a high-capacity secondary battery, weight and costs are increased. In addition, in high-capacity secondary batteries, capacity per unit cell is increased, which may significantly damage the stability of the battery and increase the costs for obtaining the same level of performance.

### SUMMARY

Embodiments of the present invention include a secondary battery having a plurality of electrode assemblies in which the electrode tabs of the electrode assemblies are easily welded (or otherwise attached) to the battery case. The secondary battery includes an insulator having receptacles for receiving a portion of each electrode assembly. Such configurations enable easy manufacture of medium- and large-sized battery modules.

According to embodiments of the invention, a secondary battery includes an insulator for mounting a plurality of electrode assemblies in a battery case (e.g., a can) and receptacles for supporting a portion of each electrode assembly.

The electrode assemblies may be jelly-roll type electrode assemblies, and may be circular or polygonal in shape.

In some embodiments, the receptacles protrude from the upper portion of the insulator, and may be generally cup-shaped such that each receptacle has an interior cavity for receiving an electrode assembly.

In some alternate embodiments, the receptacles may be depressions in the upper surface of the insulator.

When the receptacles protrude from the upper portion of the insulator, the receptacles may be shaped to support a lower portion of the electrode assembly.

The battery includes at least one insulator at the upper or lower portions of the electrode assemblies. However, according to some embodiments, the battery includes a first insulator at the upper portions of the electrode assemblies, and a second insulator at the lower portions of the insulators. In embodiments including first and second insulators at the upper and lower portions of the electrode assemblies, the first and second insulators may be a single body.

Further, the insulator may have holes through which the electrode tabs of the electrode assemblies pass.

According to embodiments of the present invention, using the inventive insulator with the receptacles, medium- and large-sized battery modules can be easily manufactured by welding (or otherwise attaching) the electrode tabs of the plurality electrode assemblies to the battery case (e.g., can), thereby protecting the battery cell having low mechanical strength as well as preventing the deformation of the electrode assemblies.

Further, the inventive insulator enables accurate positioning of the electrode assemblies, improves the accuracy of battery assembly, simplifies battery assembly and increases the structural stability of the battery.

In addition, the overall manufacturing costs can be lowered. Also, when an electrode assembly explodes, the remaining electrode assemblies do not explode (i.e., only the one electrode assembly explodes), thereby improving stability.

### BRIEF DESCRIPTION OF THE DRAWINGS

FIG. 1 is an exploded perspective view of a plurality of electrode assemblies and an insulator according to an embodiment of the present invention.

FIG. 2 is a perspective view of the electrode assemblies and insulator of FIG. 1 in which the electrode assemblies are fitted in the insulator.

FIG. 3 is a perspective view of a plurality of electrode assemblies fitted in first and second insulators according to another embodiment of the present invention.

FIG. 4 is a perspective view of a secondary battery according to another embodiment of the present invention.

FIG. 5A is a cross-sectional view taken along line A-A′ of FIG. 4 and depicts connection of an electrode tab to a cap plate according to an embodiment of the present invention.

FIG. 5B is a cross-sectional view taken along line B-B′ of FIG. 4 and depicts connection of an electrode tab to a battery case according to an embodiment of the present invention.

FIG. 6 is a cross-sectional view of a secondary battery according to yet another embodiment of the present invention.

FIG. 7 is a perspective view of a plurality of electrode assemblies fitted in an insulator according to still another embodiment of the present invention.

FIG. 8 is a perspective view of a plurality of electrode assemblies fitted in an insulator according to yet another embodiment of the present invention.

FIG. 9 is an exploded perspective view of a plurality of electrode assemblies and first and second insulators according to still yet another embodiment of the present invention.

### DETAILED DESCRIPTION

Hereinafter, a secondary battery according to embodiments of the present invention will be described with reference to the accompanying drawings.

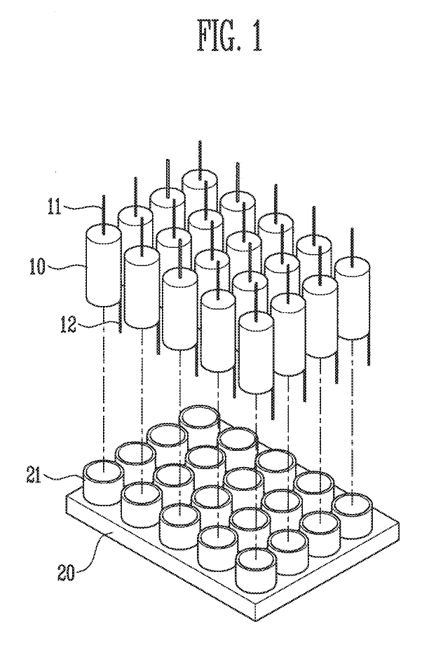

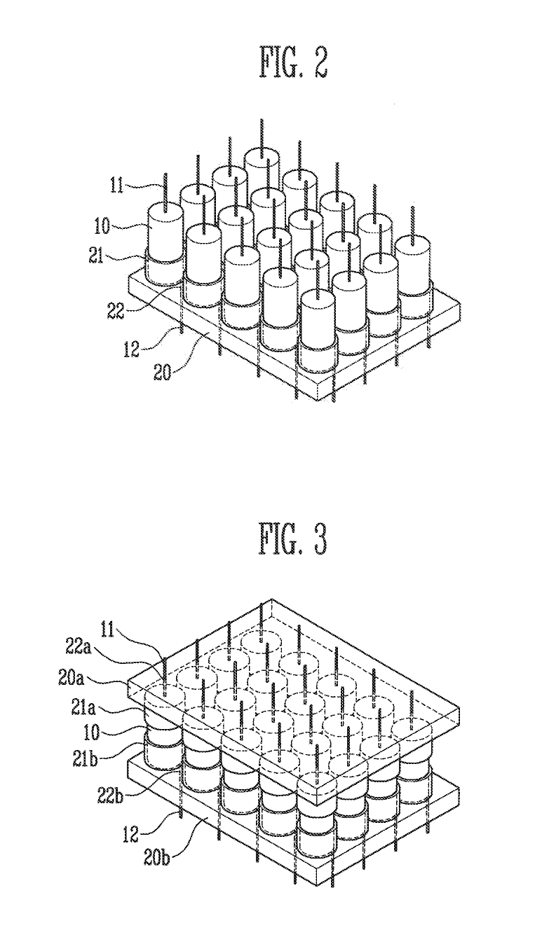

FIG. 1 is an exploded perspective view of a plurality of electrode assemblies (e.g., jelly-roll type assemblies) and an insulator according to embodiments of the present invention. FIG. 2 is a perspective view of the electrode assemblies and insulator of FIG. 1 in which the electrode assemblies are fitted in receptacles of the insulator. Referring to FIGS. 1 and 2, a medium- or large-sized secondary battery according to embodiments of the present invention includes an insulator 20 on which a plurality of electrode assemblies (e.g., circular jelly-roll type assemblies) 10 can be mounted. The insulator 20 includes a receptacle 21 for each electrode assembly, and the receptacle supports the lower portion of the electrode assembly 10. In some embodiments, the receptacles 21 protrude from an upper portion of the insulator 20 and may have inner cavities into which the lower portion of the electrode assemblies 10 are inserted. In addition, the receptacles 21 are spaced apart at intervals so that the plurality of electrode assemblies 10 can be arranged and fixed at intervals. The receptacle 21 may protrude any suitable length from the upper portion of the insulator, and the length of protrusion is not particularly limited but may extend any length suitable to firmly fix the electrode assembly 10.

Each electrode assembly 10 has a first electrode tab 11 extending from the upper portion of the assembly, and a second electrode tab 12 extending from the lower portion of the assembly. For convenience, the first electrode tab 11 extending from the upper portion is referred to as an anode tab 11 and the second electrode tab from the lower portion is referred to as a cathode tab 12.

A hole 22 for exposing the cathode tab 12 to the outside is formed in the insulator at a position corresponding to the position of the receptacle 21. The cathode tabs 12 are exposed to the outside by passing through the holes 22 of the insulator 20 upon inserting the electrode assemblies 10 into the receptacles 21. The plurality of cathode tabs 12 are exposed and aligned by the holes 22 and can then be easily welded to the battery cases (e.g., cans).

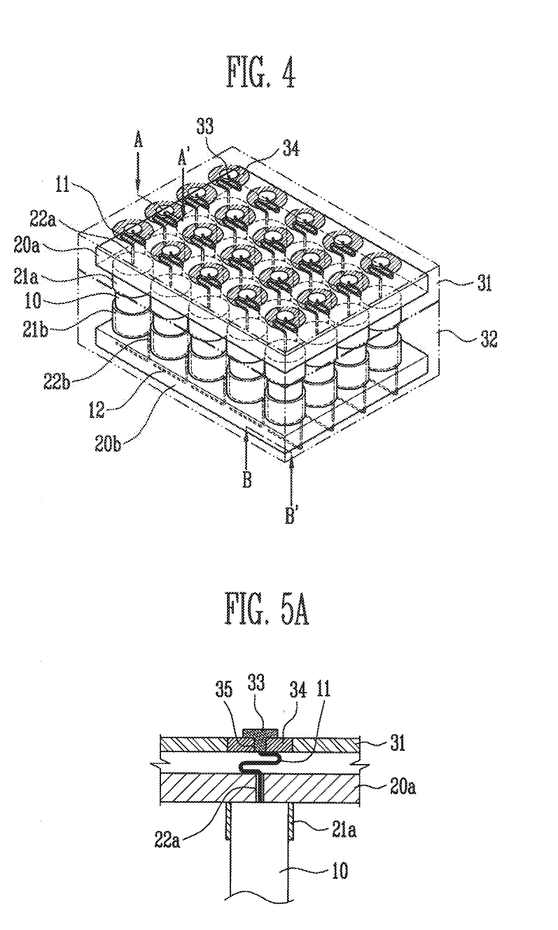

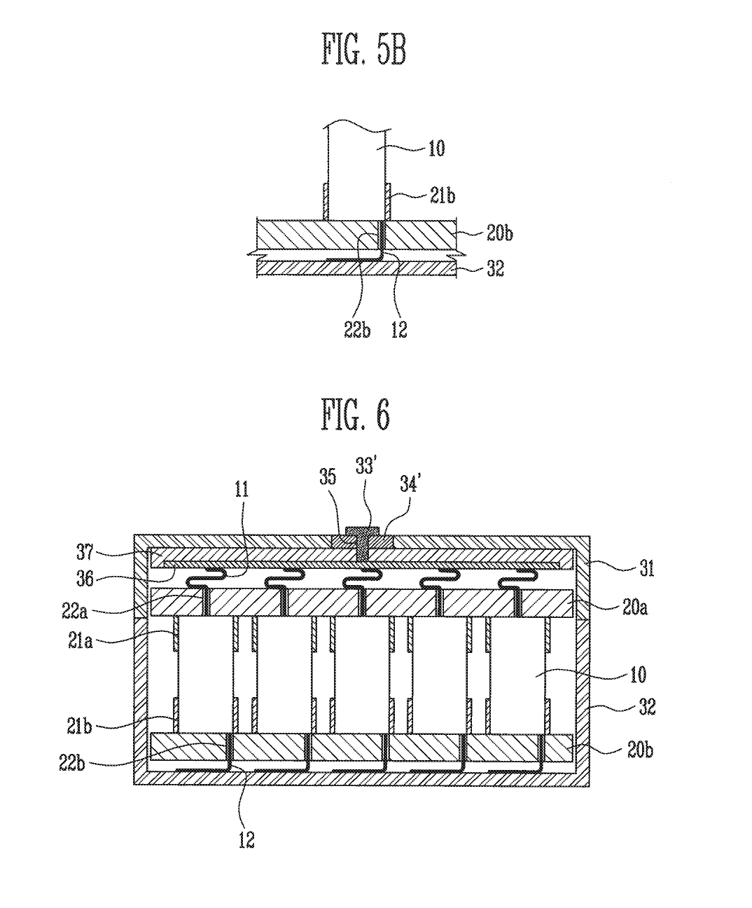

The insulator 20 including the receptacles 21 into which the electrode assemblies 10 are fitted is inserted into the battery case 32, as shown in FIG. 4. Upon insertion of the insulator assembly into the battery case, the cathode tabs 12 can be welded (or otherwise attached) to the battery case, as shown in FIGS. 4 and B. The connection of the anode tabs 11 and cathode tabs 12 to the cap plate 31 and battery case 32, respectively, is described below with reference to FIGS. 4 to 5b. Also, although FIG. 4 depicts first and second insulators 20a and 20b on the upper and lower portions of the electrode assembles, the battery according to embodiments of the present invention may include a single insulator 20 positioned only at the upper portion or only at the lower portion of the plurality of electrode assemblies 10.

The number of receptacles of the insulator 20 is not limited, and the insulator 20 may accommodate any number of electrode assemblies, for example two or more electrode assemblies 10. Further, the insulator 20 may be made of any suitable materials, such as polypropylene, polyethylene, polyimide, etc.

The electrode assembly 10 includes an anode plate having an anode active material layer coated on a surface of an anode collector, a cathode plate having a cathode active material layer on a surface of a cathode collector, and a separator positioned between the anode plate and the cathode plate. The electrode assembly 10 is wound so that the separator electrically insulates the anode plate and the cathode plate.

The anode plate includes a thin metal plate with good conductivity. For example, the anode plate may include an anode collector made of aluminum (Al) foil, and the anode active material layer may be coated on both sides of the foil. Each end of the anode plate includes an anode non-coated region in which the anode active material layer is not coated on the collector. One end of the anode non-coated region is bonded to the anode tab 11, and the anode tab 11 is generally made of an aluminum (Al) material and protrudes from the upper portion of the electrode assembly 10 by a length.

The cathode plate includes a cathode collector made of a thin metal plate, for example, a copper (Cu) or nickel (Ni) foil, and the cathode active material layer is coated on both sides of the foil. Each end of the cathode plate includes a cathode non-coated region in which the cathode active material layer is not coated on the collector. One end of the cathode non-coated region is bonded to the cathode tab 12, and the cathode tab 12 is generally made of a nickel (Ni) material and protrudes from the lower portion of the electrode assembly 10 by a length.

FIG. 3 is a perspective view of a plurality of electrode assemblies fitted in first and second insulators according to another embodiment of the present invention. FIG. 4 is a perspective view of a secondary battery according to a second embodiment of the present invention. Referring to FIGS. 3 and 4, in some embodiments, the insulator 20 may include a first insulator 20a positioned on the upper portions of the plurality of electrode assemblies 10, and a second insulator 20b positioned on the lower portions of the plurality of electrode assemblies 10. Such a construction enables easy alignment and positioning of the anode tabs 11 protruding from the upper portions of the electrode assemblies 10 and the cathode tabs 12 protruding from the lower portions of the electrode assemblies 10.

As shown in FIGS. 3 and 4, the first insulator 20a includes first receptacles 21a into which the upper portions of the plurality of electrode assemblies 10 are inserted. Also, the second insulator 20b includes second receptacles 21b into which the lower portions of the plurality of electrode assemblies 10 are inserted. The first and second receptacles 21a and 21b protrude from the first and second insulators 20a and 20b, respectively, and each receptacle may have an inner cavity into which the its corresponding electrode assembly can be inserted. The first and second receptacles 21a and 21b, respectively, may be symmetrically positioned. That is, the first receptacles 21a may correspond in position on the first insulator 20a to the positions of the second receptacles 21b on the second insulator 20b, as shown in FIGS. 3 and 4.

The first receptacles 21a receive the upper portions of the electrode assemblies 10, and each receptacle 21a includes a first hole 22a for exposing the anode tabs 11 to the outside. The second receptacles 21b receive the lower portions of the electrode assemblies 10, and each receptacle 21b includes a second hole 22b for exposing the cathode tabs 12 to the outside. As a result, the anode tabs 11 on the upper portions of the electrode assemblies 10 pass through the first holes 22a in the first insulator 20a, and the cathode tabs 12 on the lower portions of the electrode assemblies 10 pass through the second holes 22b in the second insulator 20b. The insulator assembly (including the plurality of electrode assemblies 10 fitted in the first and second insulators 20a and 20b) is then inserted into the battery case (e.g., a can) 32, and a cap plate 31 is placed on the upper portion of the insulator assembly to seal the battery. Upon inserting the insulator assembly into the battery case 32 and attaching the cap plate 31, the anode tabs 11 extending through the first holes 22a are welded (or otherwise attached) to anode leads 33 formed in the cap plate 31, and the cathode tabs 12 extending through the second holes 22b are welded (or otherwise attached) to the interior of the battery case 32.

As shown in FIG. 5A, in some embodiments, the anode tabs 11 are connected to the cap plate via anode leads 33. The cap plate 31 can be insulated from the anode leads 33 via gaskets 34. In order to connect the anode tabs 11 to the anode leads 33, the first holes 22a are positioned in the first insulator to correspond in position to the position of the anode leads 33 in the cap plate. This constructions enables easy connection (e.g., welding) of the anode tabs 11 to the anode leads 33. Although the battery case 32 and cap plate 31 have been described as having a positive polarity, the battery case and the cap plate may also have the opposite polarity.

The plurality of electrode assemblies 10 may be positioned on the insulators such that the anode tabs 11 and the cathode tabs 12 are accurately positioned at the positions of attachment (e.g., welding) to the battery case 32 or cap plate 31. That is, the receptacles 21a and 21b on the insulators 20a and 20b are positioned such that their corresponding electrode assemblies 10 are accurately located in the battery case 32 such that each of the anode tabs 11 and cathode tabs 12 can be easily and accurately connected (e.g., welded) to the battery case 32 or cap plate 31. With such accurate positioning of the plurality of electrode assemblies, battery assembly can be simplified, making it easy to manufacture the battery cell and increase the structural stability of the module. In addition, such a configuration protects the electrode assemblies 10 (which have low mechanical strength) and helps to prevent deformation of the electrode assemblies 10.

FIG. 5A is a cross-sectional view taken along line A-A′ of FIG. 4, and depicts the connection of an anode tab 11 to an anode lead 33 in the cap plate 31. Referring to FIG. 5A, the anode tab 11 (which protrudes from the upper portion of the electrode assembly 10 fitted in the first receptacle 21a) extends through the first hole 22a of the first insulator 20a. The exposed anode tab 11 is welded (or otherwise attached) to the anode lead 33 in a bent configuration so as not to contact the cap plate 31. The anode lead 33 may be insulated from the cap plate 31 by a gasket 34. The gasket 34 has an insertion hole 35 generally in its center into which the anode lead 33 can be inserted such that the anode lead 33 can contact the anode tab 11. As shown in FIG. 5A, the first hole 22a in the first insulator 20a guides the position of the anode tab 11 enabling easy connection (e.g., welding) of the anode lead 33 and the anode tab 11.

FIG. 5B is a cross-sectional view taken along line B-B′ of FIG. 4, and depicts the connection of a cathode tab 12 to the battery case 32. Referring to FIG. 5B, the cathode tab 12 (which protrudes from the lower portion of the electrode assembly 10 fitted in the second receptacle 21b) extends through the second hole 22b of the second insulator 20b. Since the can 32 itself is positive, the cathode tab 12 extending through the second hole 22b is welded (or otherwise attached) to the interior of the can 32 in a bent configuration.

FIG. 6 is a perspective view of a battery module according to yet another embodiment of the present invention. Referring to FIG. 6, the cathode tab 12 is attached to the battery case 32 in the same manner as in the battery module of FIG. 4. However, the attachment of the anode tab 11 to the cap plate differs from that in FIG. 4. As shown in FIG. 6, the cap plate 31 includes a single anode lead 33′ to which the anode tabs 11 are attached. The anode tabs 11 protruding from the upper portion of the first insulator 20a are each welded (or otherwise connected) to an electrode lead connector 36 which is electrically connected to a single anode lead 33′ inserted in an insertion hole 35 of a gasket 34′. According to this configuration, the cap plate 31 includes only one anode lead 33′, enabling a battery module having a simpler structure.

A gasket 34′ is positioned in the cap plate 31 to insulate the anode lead 33′ from the cap plate 31. The cap plate may further include an insulating plate 37 between the electrode lead connector 36 and the cap plate 31 so that the electrode lead connector 36 having a negative polarity and the cap plate 31 having a positive polarity can be insulated from each other.

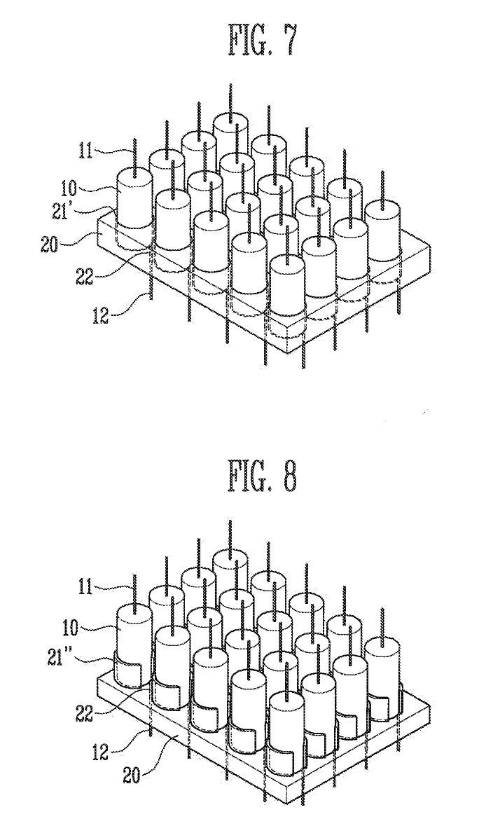

FIG. 7 is a perspective view of a plurality of electrode assemblies fitted in an insulator according to still another embodiment of the present invention. Referring to FIG. 7, medium- and large-sized battery modules can be manufactured using an insulator 20 in which a plurality of electrode assemblies 10 is inserted. The insulator 20 includes receptacles 21′ for supporting the lower portions of the plurality of electrode assemblies 10. As shown in FIG. 7, the receptacles 21′ are depressions in a surface of the insulator 20, and the lower portions of the electrode assemblies 10 can be inserted into the depressions. The depressions may have any suitable depth capable of supporting the electrode assemblies 10. For example, the depressions may have a depth suitable to surround the lower portions of the electrode assemblies 10.

The holes 22 in the insulator through which the cathode tabs 12 of the electrode assemblies 10 extend are positioned in the receptacles 21′ of the insulator so that the cathode tabs 12 extend through the holes 22 of the insulator 20 when the electrode assemblies 10 are inserted into the receptacles 21′. The holes 22, therefore, serve to align the plurality of cathode tabs 12, thereby enabling easy attachment (e.g., by welding) of the tabs 12 to the battery case.

The insulator 20 (having the plurality of electrode assemblies 10 mounted in the receptacles 21′) is inserted into the battery case, thus enabling the accurate positioning of the electrode assemblies 10 within the battery case.

FIG. 8 is a perspective view of a plurality of electrode assemblies fitted in an insulator according to still yet another embodiment of the present invention. Referring to FIG. 8, each receptacle 21″ of the insulator 20 supports at least a portion of a periphery of the lower portion of its corresponding electrode assembly 10. As shown, the receptacles 21″ protrude from the upper surface of the insulator 20, and each receptacle 21″ includes an outer peripheral wall having at least one opening. In other words, the receptacle 21″ is constructed in any manner such that a minimum amount of support for the electrode assembly 10 is obtained. In one exemplary embodiment, for example, the outer peripheral wall of the receptacle 21″ may include more than one opening, and the openings in the wall may repeat at any suitable interval.

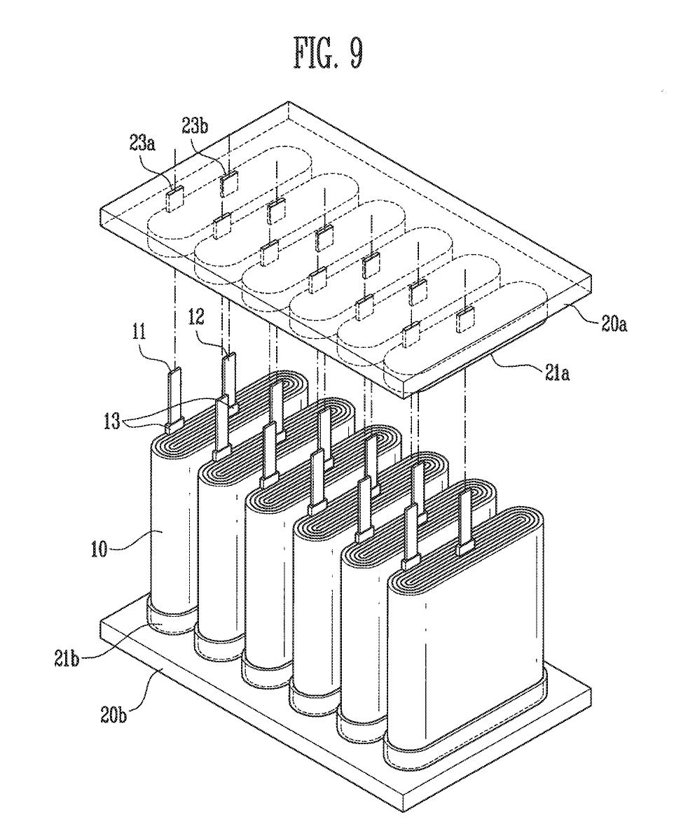

FIG. 9 is an exploded perspective view of a plurality of electrode assemblies fitted in first and second insulators according to yet another embodiment of the present invention. Referring to FIG. 9, medium- and large-sized battery modules can be manufactured by inserting an insulator 20 equipped with a plurality of polygonal electrode assemblies 10 (i.e., rather than circular assemblies) into a battery case (not shown). As shown in FIG. 9, the insulator 20 includes a first insulator 20a positioned on top of the electrode assemblies 10, and a second insulator 20b positioned on the bottom of the electrode assemblies 10. First receptacles 21a support the upper portions of the electrode assemblies 10 and are formed on the first insulator 20a. Second receptacles 21b support the lower portions of the electrode assemblies 10 and are formed on the second insulator 20b.

As shown in FIG. 9, the first and second receptacles 21a and 21b protrude from the first and second insulators 20a and 20b, respectively, and are spaced apart to define the positions for insertion of the electrode assemblies 10. Although the receptacles 21a and 21b are shown in FIG. 9 as surrounding the top or bottom portions of the electrode assemblies, the receptacles 21a and 21b may take any suitable shape, including any of the shapes discussed above with respect to FIGS. 1-8. For example, the receptacles 21a and 21b may be shaped to partially support the top or bottom portions of the electrode assemblies 10, as shown in FIG. 8.

Since the polygonal electrode assemblies 10 have anode tabs 11 and cathode tabs 12 both protruding in the same direction, the first insulator 20a includes first holes 23a through which the anode tabs 11 extend, and second holes 23b through which the cathode tabs extend. The first and second holes 23a and 23b, respectively, are formed in the receptacles 21a of the first insulator 20a in positions corresponding to the positions of the anode tabs 11 and cathode tabs 12, respectively. The anode tabs 11 extending through the first holes 23a, and the cathode tabs 12 extending through the second holes 23b are aligned with their positions of attachment to the battery case, thereby enabling easy attachment (e.g., by welding) of the tabs to the case.

Although the first and second receptacles 21a and 21b are depicted in FIG. 9 as protruding from the first and second insulators 20a and 20b, respectively, they may alternatively be depressions in the surfaces of the first and second insulators 20a and 20b, as shown in FIG. 7. Further, since both the anode tabs 11 and cathode tabs 12 protrude from the electrode assemblies 10 in the same direction, the insulator may include a single insulator positioned over the portion of the electrode assemblies from which the tabs extend (e.g., the upper portions).

To make a polygonal electrode assembly 10, a separator is positioned between an anode plate and a cathode plate, and the structure is wound to form a jelly-roll type electrode assembly. The anode tab 11 is connected to the anode plate and protrudes from the top of the electrode assembly 10. The cathode tab 12 is connected to the cathode plate and also protrudes from the top of the electrode assembly 10. The anode tab 11 and cathode tab 12 are spaced apart from each other and electrically connected to the electrode assembly 10. Further, a lamination tape 13 may be wound around the portion of the anode tab 11 and cathode tab 12 connected to the electrode assembly 10. The lamination tape 13 intercepts heat generated from the anode tab 11 or cathode tab 12 and prevents the edge of the anode tab 11 or the cathode tab 12 from pressing against the electrode assembly 10.

Although holes are formed in the insulator to expose the electrode tabs in the above embodiments, through-holes for discharging heat generated from the electrode assemblies to the outside may also be formed.

While the present invention has been illustrated and described with reference to certain exemplary embodiments, it is understood by those of ordinary skill in the art that various modifications and changes may be made to the described embodiments without departing from the spirit and scope of the present invention as defined by the following claims.

What is claimed is:

1. A battery cell, comprising:
at least two electrode assemblies, each electrode assembly comprising an anode, a cathode, a separator between the anode and the cathode, and an electrode tab extending from either the anode or the cathode;
at least one insulator plate having at least one opening through which at least one of the electrode tabs passes, and comprising a receptacle for each electrode assembly, each receptacle being configured to receive at least a portion of its corresponding electrode assembly.

2. The battery cell of claim 1, wherein the insulator plate comprises a surface, wherein each receptacle comprises at least one wall that protrudes beyond the surface.

3. The battery cell of claim 1, wherein the at least one insulator plate (20) comprises first and second insulator plates.

4. The battery cell of claim 3, wherein each electrode tab of each electrode assembly comprises a first electrode tab extending from a first end of the electrode assembly and a second electrode tab extending from a second end of the electrode assembly, the at least one opening in the insulator plate comprising a first opening in the first insulator plate, and a second opening in the second insulator plate, wherein the first electrode tab extends through the first opening in the first insulator plate, and the second electrode tab extends through the second opening in the second insulator plate.

5. The battery cell of claim 4, further comprising a battery case and a cap plate assembly enclosing the insulator plates and electrode assemblies, wherein the first electrode tab of each electrode assembly extends through the first opening in the first insulator plate and contacts the battery case, and the second electrode tab of each electrode assembly extends through the second opening in the second insulator plate and contacts the cap plate assembly.

6. The battery cell of claim 5, wherein the cap plate assembly comprises:
a cap plate; and
an electrode lead for each electrode assembly, wherein the second electrode tab of each electrode assembly contacts its corresponding electrode lead.

7. The battery cell of claim 6, wherein the cap plate further comprises a gasket configured to insulate the electrode lead from the cap plate.

8. The battery cell of claim 6, wherein the cap plate assembly comprises:
an electrode lead connector, wherein the second electrode tab of each electrode assembly contacts the electrode lead connector; and
an electrode lead connected to the electrode lead connector.

9. The battery cell of claim 8, wherein the cap plate assembly further comprises an insulator plate.

10. The battery cell of claim 1, wherein the electrode tab of each electrode assembly comprises a first electrode tab and a second electrode tab both extending from a first end, the insulator plate comprising first and second openings for each electrode assembly, wherein the first electrode tab extends through the first opening, and the second electrode tab extends through the second opening.

11. The battery cell of claim 1, wherein each receptacle is configured to receive at least a portion of a periphery of a first end of its corresponding battery unit cell.

12. The battery cell of claim 11, wherein each receptacle comprises an outer wall having at least one opening.

13. The battery cell of claim 11, wherein each receptacle comprises an outer peripheral wall.

14. The battery cell of claim 1, wherein each receptacle comprises a depression in a surface of the insulator plate.
